(19) United States
(12) Patent Application Publication
(10) Pub. No.: US 2024/0134390 A1
(43) Pub. Date: Apr. 25, 2024

(54) INFORMATION PROCESSING SYSTEM, INFORMATION PROCESSING METHOD, AND INFORMATION PROCESSING DEVICE

(71) Applicant: SONY GROUP CORPORATION, TOKYO (JP)

(72) Inventors: ALEXANDRE WILLIAM CONUS, TOKYO (JP); TETSUYA NARITA, TOKYO (JP); TOMOKO KATSUHARA, TOKYO (JP); NOBUKAZU HIRAI, TOKYO (JP); TETSURO GOTO, TOKYO (JP)

(21) Appl. No.: 18/547,361

(22) PCT Filed: Jan. 19, 2022
(86) PCT No.: PCT/JP2022/001858

§ 371 Date: Aug. 21, 2023

(30) Foreign Application Priority Data
Mar. 4, 2021 (JP) 2021-034824

(51) Int. Cl. G05D 1/644; G05D 1/243

(52) U.S. Cl. CPC G05D 1/644; G05D 1/2435

(57) ABSTRACT

An information processing system according to an embodiment of the present disclosure includes a first information processing device to be provided to a movable body and a second information processing device to be provided to a portion that differs from the movable body. The first information processing device includes a sensor portion, a generation portion, a control portion, and an integration portion. The sensor portion senses a first external environment. The generation portion uses sensor data acquired from the sensor portion to generate a first map. The control portion controls motion of a manipulator on the basis of the first map. The integration portion uses position information of inside the first external environment, with which portion the manipulator is in contact, integrates the first map and a second map acquired from the second information processing device with each other, and generates an integration map.

### TECHNICAL FIELD

The present disclosure relates to an information processing system, an information processing method, and an information processing device.

### BACKGROUND ART

It has been disclosed a technology relating to a movable body such as a robot that recognizes an external environment and autonomously moves in accordance with the recognized environment (for example, see Patent Literature 1).

### CITATION LIST

### Patent Literature

Patent Literature 1: Japanese Unexamined Patent Application Publication (Published Japanese Translation of PCT Application) No. 2014-209381

### SUMMARY OF THE INVENTION

In such an environment that a robot faces difficulties in performing recognition, stable and prompt manipulation has been difficult so far. It is therefore desirable to provide an information processing system, an information processing method, and an information processing device, which make it possible to perform stable and prompt manipulation.

An information processing system according to an embodiment of the present disclosure includes a first information processing device to be provided to a movable body and a second information processing device to be provided to a portion that differs from the movable body. The first information processing device includes a sensor portion, a generation portion, a control portion, and an integration portion. The sensor portion senses a first external environment. The generation portion uses sensor data acquired from the sensor portion to generate a first map. The control portion controls motion of a manipulator on the basis of the first map. The integration portion uses position information of inside the first external environment, with which portion the manipulator is in contact, integrates the first map and a second map acquired from the second information processing device with each other, and generates an integration map.

An information processing method according to an embodiment of the present disclosure includes three acts described below:
(1) performing sensing to generate a first map of a first external environment;
(2) controlling motion of a manipulator on the basis of the first map; and
(3) using position information of inside the first external environment, with which portion the manipulator is in contact, integrating the first map and a second map of a second external environment including at least a portion of the first external environment with each other, and generating an integration map.

An information processing device according to an embodiment of the present disclosure includes a sensor portion, a generation portion, a control portion, and an integration portion. The sensor portion senses a first external environment. The generation portion uses sensor data acquired from the sensor portion to generate a first map. The control portion controls motion of a manipulator on the basis of the first map. The integration portion uses position information of inside the first external environment, with which portion the manipulator is in contact, integrates the first map and a second map acquired from a second information processing device with each other, and generates an integration map. The information processing system, the information processing method, and the information processing device according to the embodiment of the present disclosure use position information of inside a first external environment, with which portion a manipulator is in contact, integrate a first map and a second map with each other, and generate an integration map. It is thereby possible to accurately identify a portion where the first map and the second map correspond to each other.

### BRIEF DESCRIPTION OF DRAWING

FIG. 1 is a diagram illustrating a schematic example configuration of a movable body used in an information processing system according to the present disclosure.

FIG. 2 is a diagram illustrating an example article that is placed inside an external environment and that serves as a measurement target in the information processing system illustrated in FIG. 1.

FIG. 3 is a diagram illustrating an example of a World coordinate system, a Robot coordinate system, and an environment coordinate system used in the information processing system illustrated in FIG. 1.

FIG. 4 is a diagram for explaining terms illustrated in FIG. 3.

FIG. 5 is a diagram illustrating an example of the World coordinate system, the Robot coordinate system, and the environment coordinate system used in the information processing system illustrated in FIG. 1.

FIG. 6 is a diagram for explaining terms illustrated in FIG. 5.

FIG. 7 is a diagram illustrating an example of the World coordinate system, the Robot coordinate system, and the environment coordinate system used in the information processing system illustrated in FIG. 1.

FIG. 8 is a diagram for explaining terms illustrated in FIG. 7.

FIG. 9 is a diagram illustrating an example of the World coordinate system, the Robot coordinate system, and the environment coordinate system used in the information processing system illustrated in FIG. 1.

FIG. 10 is a diagram for explaining terms illustrated in FIG. 8.

FIG. 11 is a diagram illustrating example functional blocks of the information processing system according to an embodiment of the present disclosure.

FIG. 12 is a diagram illustrating an example information processing procedure executed in the information processing system illustrated in FIG. 11.

FIG. 13 is a diagram illustrating an example article that is placed inside an external environment and that serves as a measurement target in the information processing system illustrated in FIG. 11.

FIG. 14 is a diagram illustrating an example article that is placed inside an external environment and that serves as a measurement target in the information processing system illustrated in FIG. 11.

FIG. 15 is a diagram illustrating an example article that is placed inside an external environment and that serves as a measurement target in the information processing system illustrated in FIG. 11.

FIG. 16 is a diagram illustrating a modification example to the functional blocks of the information processing system illustrated in FIG. 11.

FIG. 17 is a diagram illustrating a modification example to the functional blocks of the information processing system illustrated in FIG. 11.

### MODES FOR CARRYING OUT THE INVENTION

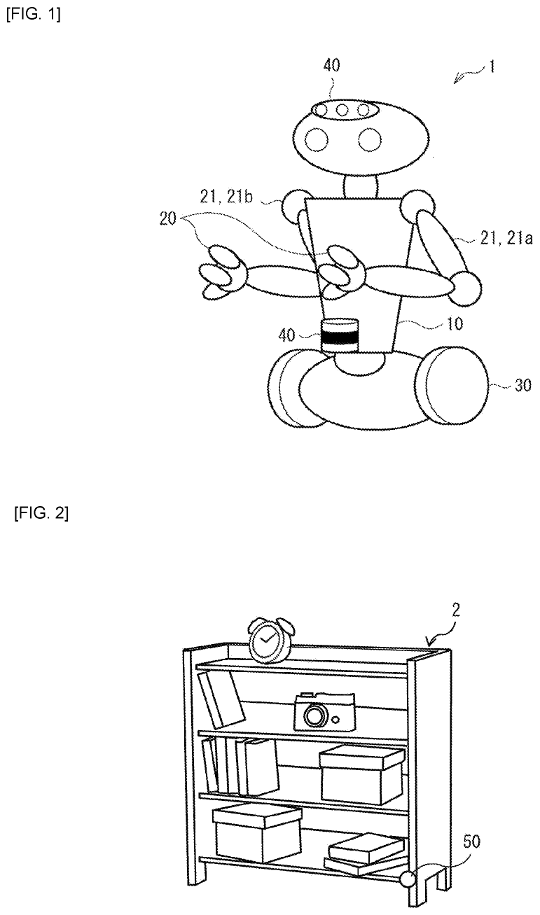

An embodiment of the present disclosure will now be described herein in detail with reference to the accompanying drawings. The below description merely reveals specific but non-limiting examples of the present disclosure. However, the present disclosure is not limited to those described below. The present disclosure is not also limited to arrangements, sizes, dimensional ratios, and other factors of components illustrated in the drawings. It is to be noted that description is given in the following order.
1. Embodiment (FIGS. 1 to 12)

Example when contact position information pertaining to a manipulator is used to integrate maps
2. Modification Examples
Modification Example A

Example of simultaneously coming into contact with a plurality of portions
Modification Example B

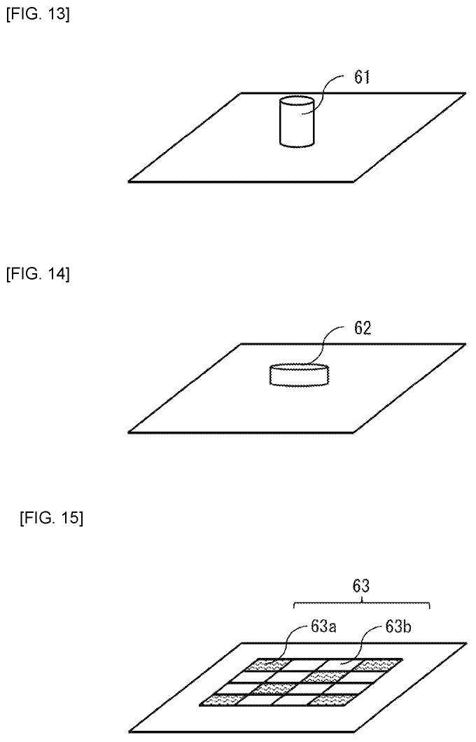

Example of sequentially coming into contact with a plurality of portions
Modification Example C (FIGS. 13 to 16)

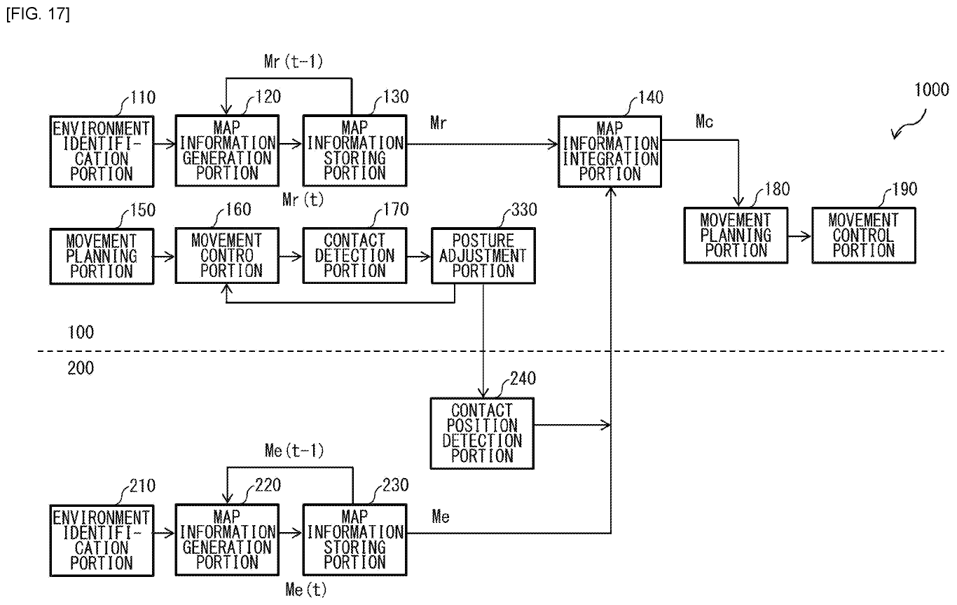

Examples of each placing an article having a distinctive shape, distinctive hardness, or distinctive texture inside an external environment
Modification Example D (FIG. 17)

Example of adjusting a robot in posture

### 1. Embodiment

FIG. 1 illustrates a schematic example configuration of a robot machine 1 used in an information processing system 1000 according to an embodiment of the present disclosure. The robot machine 1 includes, for example, a main body 10, contact sensors 20, two manipulators 21, a moving mechanism 30, and a non-contact sensor 40. The robot machine 1 corresponds to one specific example of a “movable body” according to the present disclosure. The two manipulators 21 correspond to one specific example of “manipulators” according to the present disclosure. The non-contact sensor 40 corresponds to one specific example of a “first sensor portion” according to the present disclosure. The main body 10 includes, for example, a drive portion and a control portion for the robot machine 1 to serve as a center portion to which portions of the robot machine 1 are attached. The control portion controls those provided to the robot machine 1 including the contact sensors 20, the two manipulators 21, the moving mechanism 30, and the non-contact sensor 40. The main body 10 may have a shape resembling an upper half of a human body having a head, a neck, and a torso.

The manipulators 21 are, for example, multi-articulated type robot arms respectively attached to the main body 10. One of the manipulators 21 is, for example, attached to a right shoulder of the main body 10 resembling the upper half of the human body. The other one of the manipulators 21 is, for example, attached to a left shoulder of the main body 10 resembling the upper half of the human body. The manipulators 21 may each include, for example, a link mechanism having joints at portions corresponding to a shoulder, an elbow, and a wrist of a human body.

The contact sensors 20 are, for example, pressure sensors respectively provided to end effectors (i.e., effectors) serving as terminals of the manipulators 21. The pressure sensors are able to detect changes in pressure inputted into the pressure sensors. The contact sensors 20 may be vision system tactile sensors or force sensors. The contact sensors 20 are able to each detect whether or not the end effector has come into contact with an object that is present in an ambient environment or each detect a gripping force applied by the end effector to an object.

The moving mechanism 30 is, for example, provided to a lower portion of the main body 10 and is a portion that allows the robot machine 1 to move. The moving mechanism 30 may be a wheel type moving device having two or four wheels or a leg type moving device having two or four legs. Furthermore, the moving mechanism 30 may be a hover type, propeller type, or endless track type moving device.

The non-contact sensor 40 is, for example, a sensor that is provided to the main body 10 or another portion and that detects (senses), in a non-contact manner, information relating to an ambient environment (an external environment) of the robot machine 1. The non-contact sensor 40 outputs sensor data acquired through the detection (sensing). An external environment that the non-contact sensor 40 is able to sense corresponds to one specific example of a “first external environment” according to the present disclosure. Specifically, the non-contact sensor 40 is an imaging device such as a stereo camera, a monocular camera, a color camera, an infrared camera, or a polarization camera. Note that the non-contact sensor 40 may be an environment sensor that detects weather, meteorological, or other conditions, a microphone that detects sound, or a depth sensor such as an ultrasonic sensor, a time of flight (ToF) sensor, or a light detection and ranging (LiDAR) sensor. The non-contact sensor 40 may be a position sensor such as a global navigation satellite system (GNSS) sensor.

The non-contact sensor 40 may be an imaging device that is able to capture a color image, a depth sensor such as a LiDAR sensor that is able to measure a distance to an object, or a red, green, blue, depth (RGBD) sensor that is able to simultaneously acquire an image of an object and a distance to the object. In the robot machine 1, an RGBD sensor may be provided to the head of the main body 10, while a LiDAR sensor may be provided to the torso of the main body 10, as illustrated in FIG. 1, for example.

The robot machine 1 includes, for example, the moving mechanism 30 that allows the robot machine 1 to move and the manipulators 21 including the end effectors that are each able to take an action to an object that is present in an ambient environment. That is, the robot machine 1 may be a robot machine that autonomously acts or moves. The robot machine as described above is able to act or move on the basis of an instruction that a user provides or of an autonomous trigger.

Note herein that accuracy in positioning, at which the robot machine 1 acts or moves, for example, depends on accuracy at which the robot machine 1 recognizes an ambient environment. When the robot machine 1 is able to recognize an ambient environment at higher accuracy, it is therefore possible to further enhance the accuracy at which the robot machine 1 acts or moves. In the present embodiment, sensing results of the contact sensors 20 are used in addition to a sensing result of the non-contact sensor 40 to enhance the positional accuracy of the robot machine 1 inside an environment that the robot machine 1 recognizes.

Specifically, the robot machine 1 causes one of the contact sensors 20 to come into contact with an object that the non-contact sensor 40 has detected from an ambient environment to further cause the one of the contact sensors 20 to detect the object. At this time, the robot machine 1 uses a body model of the robot machine 1 and information relating to a posture to make it possible to know, at high accuracy, a position of the one of the contact sensors 20 provided to the end effectors of the manipulators 21. The robot machine 1 uses information of an ambient environment that the non-contact sensor 40 detects and position information of the one of the contact sensors 20, which is in contact with the object that is present in the ambient environment. The robot machine 1 is therefore able to know the position of the robot machine 1 at higher accuracy.

That is, the robot machine 1 causing one of the contact sensors 20 to directly come into contact with an object is able to identify, at higher accuracy, the position of the robot machine 1 relative to the object, compared with that identified through an indirect measurement by the non-contact sensor 40. With this feature, the robot machine 1 is able to recognize its own position in an ambient environment at higher accuracy. Note that an object represents a stationary object that is present in an ambient environment of the robot machine 1 and that has a size at which the robot machine 1 is able to come into contact with.

FIG. 2 illustrates an example article that is placed inside an external environment and that serves as a measurement target in the information processing system 1000 according to the embodiment of the present disclosure. FIG. 2 illustrates a book shelf 2 serving as such an article and a non-contact sensor 50. The non-contact sensor 50 corresponds to one specific example of a “second sensor portion” according to the present disclosure.

In the book shelf 2, a plurality of racks may be provided at predetermined intervals. The racks may each have a depth. The racks may be placed with, for example, books, boxes, a camera, an alarm clock, and other articles. The non-contact sensor 50 is, for example, a sensor that is provided to the book shelf 2 or another portion and that detects, in a non-contact manner, information relating to an ambient environment (an external environment) including the depths of the racks of the book shelf 2. The non-contact sensor 50 outputs sensor data acquired through the detection (sensing). An external environment that the non-contact sensor 50 is able to sense corresponds to one specific example of a “second external environment” according to the present disclosure.

A sensing region (an external environment) of the non-contact sensor 50 includes at least a portion of a sensing region (an external environment) of the non-contact sensor 40 of the robot machine 1. For example, the book shelf 2 (and the depths of the racks of the book shelf 2) is included within the sensing region (the external environment) of the non-contact sensor 50 and also included within the sensing region (the external environment) of the non-contact sensor 40 of the robot machine 1. A map acquired through sensing by the non-contact sensor 50 corresponds to one specific example of a “second map” according to the present disclosure. A map acquired through sensing by the non-contact sensor 40 of the robot machine 1 corresponds to one specific example of a “first map” according to the present disclosure. At this time, the second map includes at least a portion of the first map. For example, map information about the book shelf 2 (and the depths of the racks of the book shelf 2) is included in both the first map and the second map.

The non-contact sensor 50 is an imaging device such as a stereo camera, a monocular camera, a color camera, an infrared camera, or a polarization camera. Note that the non-contact sensor 50 may be an environment sensor that detects weather, meteorological, or other conditions, a microphone that detects sound, or a depth sensor such as an ultrasonic sensor, a ToF sensor, or a LiDAR sensor. The non-contact sensor 50 may be a position sensor such as a GNSS sensor.

The non-contact sensor 50 may be an imaging device that is able to capture a color image, a depth sensor such as a LiDAR sensor that is able to measure a distance to an object, or an RGBD sensor that is able to simultaneously acquire an image of an object and a distance to the object.

Next, a World coordinate system W-xyz, a Robot coordinate system R-xyz, and an environment coordinate system E-xyz used in the information processing system 1000 according to the embodiment of the present disclosure will be described. The World coordinate system W-xyz is a coordinate system that serves as a reference for all the coordinate systems. The Robot coordinate system R-xyz is a coordinate system of the robot machine 1 that moves in the World coordinate system W-xyz. An origin of the Robot coordinate system R-xyz lies at a predetermined portion in the main body 10, for example. The environment coordinate system E-xyz is a coordinate system having an origin lying at a predetermined portion of a certain object (or an article) in the World coordinate system W-xyz.

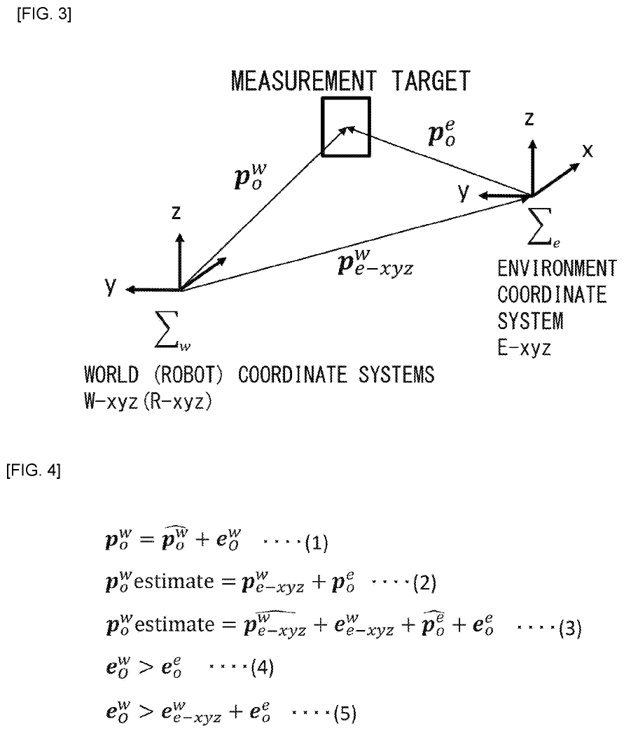

FIG. 3 illustrates the World coordinate system W-xyz, the Robot coordinate system R-xyz, and the environment coordinate system E-xyz when the Robot coordinate system R-xyz coincides with the World coordinate system W-xyz. A fact that the Robot coordinate system R-xyz coincides with the World coordinate system W-xyz means that, in short, the robot machine 1 has not yet moved but is stationary in the World coordinate system W-xyz.

Robot machines used so far utilize object coordinates p^{w}₀ to perform manipulation. In an actual case, however, the object coordinates p^{w}₀ includes an error e^{w}₀ due to a recognition error, as indicated by Expression (1) illustrated in FIG. 4. A term e^{w}₀ hat included in Expression (1) illustrated in FIG. 4 represents a correct (true) value.

In the present embodiment, on the other hand, the robot machine 1 does not utilize the object coordinates p^{w}₀. Specifically, the robot machine 1 uses Expression (2) illustrated in FIG. 4 to estimate a position of a measurement target. A term p^{w}₀ estimate, which is included in Expression (2) illustrated in FIG. 4, represents an estimated value. A term p^{w}_{e-xyz}, which is included in Expression (2) illustrated in FIG. 4, represents a value of a vector extending from an origin of the World coordinate system W-xyz and the origin of the Robot coordinate system R-xyz to the origin of the environment coordinate system E-xyz. A term p^{e}₀, which is included in Expression (2) illustrated in FIG. 4, represents a value of a vector extending from the origin of the environment coordinate system E-xyz to a measurement target. At this time, p^{e}_{e-xyz} and p^{e}₀ include, as indicated by Expression (3) illustrated in FIG. 4, errors e^{w}_{e-xyz} and e^{w}₀ due to a recognition error. Terms p^{w}_{e-xyz} hat and p^{e}₀ hat, which are included in Expression (3) illustrated in FIG. 4, represent correct (true) values.

In a method according to the present embodiment, compared with methods used so far, the distance from the robot machine 1 to the non-contact sensor 50 is shorter than the distance from the robot machine 1 to the measurement target, resulting in a higher degree of freedom in determining a portion at which the non-contact sensor 50 is to be provided. In that case, Expression (4) illustrated in FIG. 4 is satisfied. It is therefore important that Expression (5) illustrated in FIG. 4 be satisfied. Allowing one of the manipulators 21 of the robot machine 1 to come into direct contact with an object in an external environment makes it possible to lower the error e^{w}_{e-xyz} included in p^{w}_{e-xyz}.

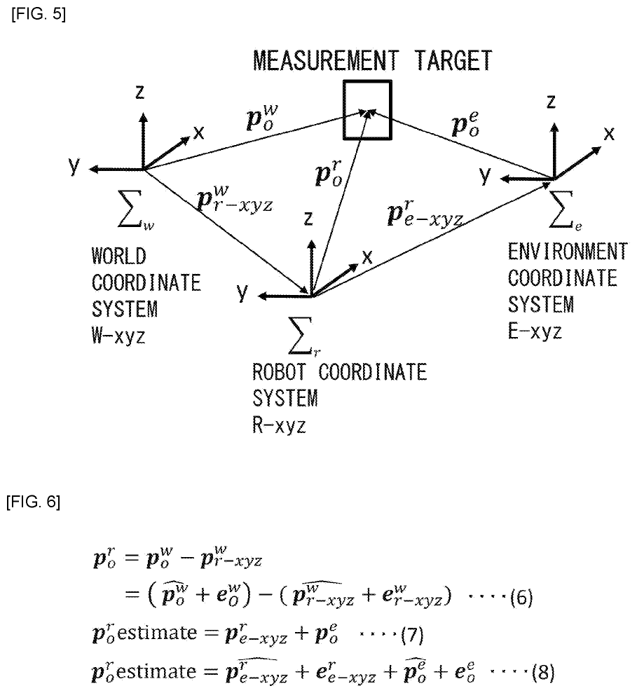

FIG. 5 illustrates the World coordinate system W-xyz, the Robot coordinate system R-xyz, and the environment coordinate system E-xyz when the Robot coordinate system R-xyz does not coincide with the World coordinate system W-xyz. A fact that the Robot coordinate system R-xyz does not coincide with the World coordinate system W-xyz means that, in short, the robot machine 1 has moved in the World coordinate system W-xyz.

Robot machines used so far each utilize the object coordinates p^{w}₀ and its own position e^{w}_{r-xyz} to finally set the object coordinates p^{w}₀ as a target to perform manipulation. In an actual case, however, the object coordinates p^{w}₀ and its own position e^{w}_{r-xyz} include errors e^{w}₀ and e^{w}_{r-xyz} due to a recognition error, as indicated by Expression (6) illustrated in FIG. 6. Terms p^{w}₀ hat and p^{w}_{r-xyz} hat, which are included in Expression (6) illustrated in FIG. 6, represent correct (true) values.

In the present embodiment, on the other hand, the robot machine 1 does not utilize the object coordinates p^{w}₀. Specifically, the robot machine 1 uses Expression (7) illustrated in FIG. 6 to estimate a position of a measurement target. A term p^{w}₀ estimate, which is included in Expression (7) illustrated in FIG. 6, represents an estimated value. A term p^{r}_{e-xyz}, which is included in Expression (7) illustrated in FIG. 6, represents a value of a vector extending from the origin of the Robot coordinate system R-xyz to the origin of the environment coordinate system E-xyz. A term p^{e}₀, which is included in Expression (7) illustrated in FIG. 6, represents a value of a vector extending from the origin of the environment coordinate system E-xyz to a measurement target. At this time, p^{r}_{e-xyz} and p^{e}₀ include, as indicated by Expression (8) illustrated in FIG. 6, errors e^{r}_{e-xyz} and e^{e}₀ due to a recognition error. Tterms p^{r}_{e-xyz} hat and p^{e}₀ hat, which are included in Expression (8) illustrated in FIG. 6, represent correct (true) value. In the present embodiment, allowing one of the manipulators 21 to come into direct contact with an object in an external environment then makes it possible to estimate the error e^{w}_{r-xyz} included in p^{w}_{r-xyz}.

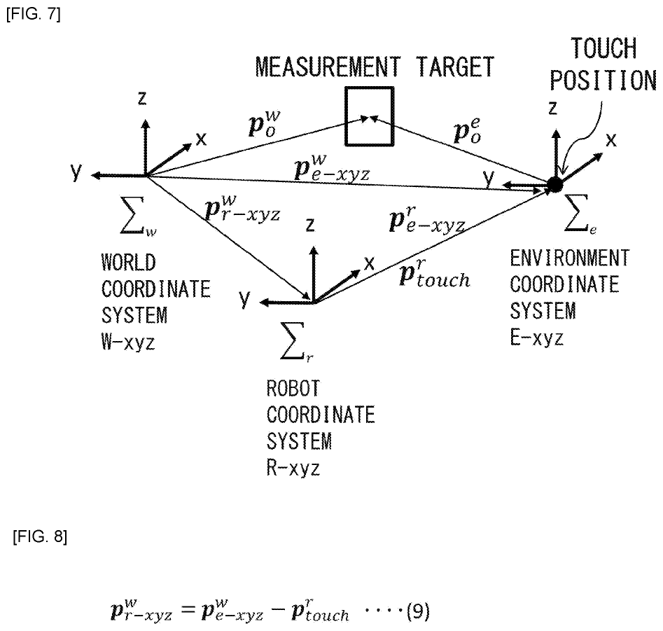

FIG. 7 illustrates the coordinate systems when one of the manipulators 21 is caused to come into contact with an object at the origin of the environment coordinate system E-xyz. When one of the manipulators 21 is caused to come into contact with an object at the origin of the environment coordinate system E-xyz, p^{r}_{e-xyz} becomes equal to a vector p^{r}_{touch} that extends from the origin of the Robot coordinate system R-xyz to the touch position and that the control portion of the robot machine 1 recognizes. Note herein that the vector p^{r}_{touch} and a vector p^{w}_{e-xyz} extending from the origin of the World coordinate system W-xyz to the touch position are all highly accurate values. The control portion of the robot machine 1 is therefore able to use Expression (9) illustrated in FIG. 8 to acquire p^{w}_{r-xyz} with a smaller error of e^{w}_{r-xyz}.

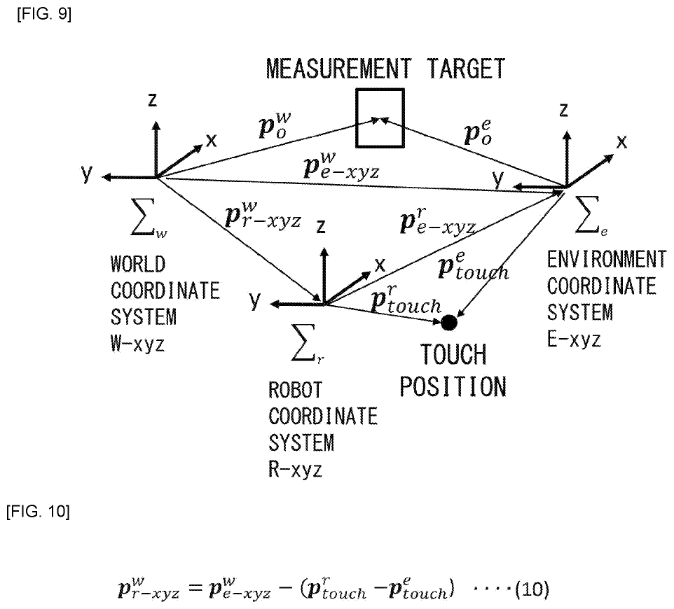

FIG. 9 illustrates the coordinate systems when one of the manipulators 21 is caused come into contact with an object at a position that differs from the origin of the environment coordinate system E-xyz. When the one of the manipulators 21 is caused to come into contact with the object at the position that differs from the origin of the environment coordinate system E-xyz, p^{r}_{e-xyz} becomes equal to a result of p^{r}_{touch}−p^{e}_{touch}. The term p^{e}_{touch} represents a vector extending from the origin of the environment coordinate system E-xyz to the touch position. Note herein that, since Expression (4) illustrated in FIG. 4 is satisfied, the vector p^{r}_{touch} and the vector p^{e}_{touch} are all highly accurate values. The control portion of the robot machine 1 is therefore uses Expression (10) illustrated in FIG. 10 to acquire p^{w}_{r-xyz} with a smaller error of e^{w}_{r-xyz}.

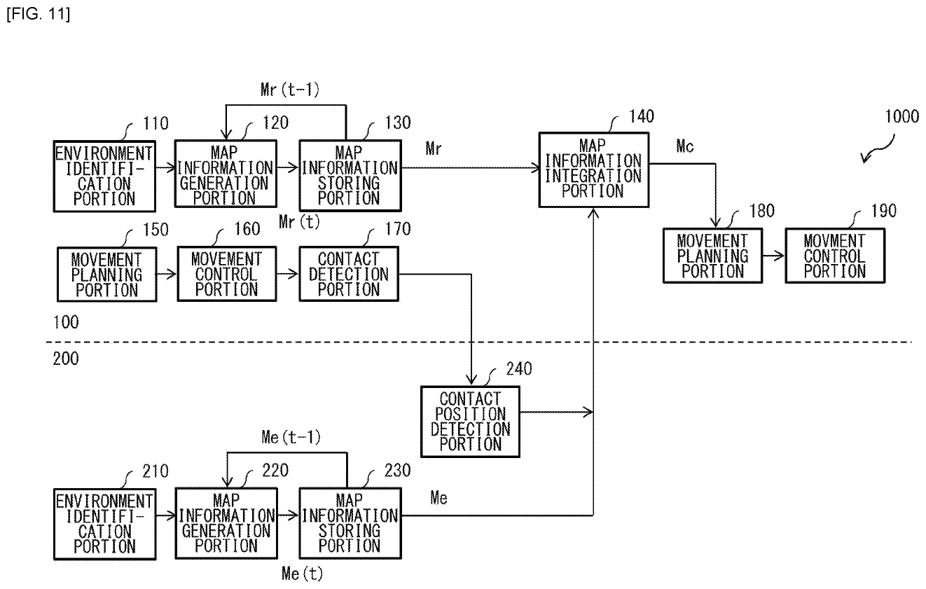

Next, functional blocks of the information processing system 1000 will be described. FIG. 11 illustrates an example of the functional blocks of the information processing system 1000. The information processing system 1000 includes an information processing device 100 provided to the robot machine 1 and an information processing device 200 provided to a portion that differs from the robot machine 1. The information processing device 100 and the information processing device 200 are communicably coupled to each other through wireless communications, for example. The information processing device 100 and the information processing device 200 may each include a communication portion that performs wireless communications based on a wireless local are network (LAN) or Bluetooth (registered trademark), for example.

The information processing device 100 includes, for example, an environment identification portion 110, a map information generation portion 120, a map information storing portion 130, a map information integration portion 140, a movement planning portion 150, a movement control portion 160, a contact detection portion 170, a movement planning portion 180, and a movement control portion 190. The map information generation portion 120 corresponds to one specific example of a “first generation portion” according to the present disclosure. The map information storing portion 130 corresponds to one specific example of a “first memory portion” according to the present disclosure. The map information integration portion 140 corresponds to one specific example of an “integration portion” according to the present disclosure. The movement planning portion 150 and the movement control portion 160 correspond to one specific example of a “control portion” according to the present disclosure.

The information processing device 100 may be wholly provided inside an external environment. Some of the components of the information processing device 100 (for example, the environment identification portion 110 and the movement control portion 190) may only be provided inside an external environment. At this time, the rest of the components of the information processing device 100 (for example, the map information generation portion 120, the map information storing portion 130, the map information integration portion 140, the movement planning portion 150, the movement control portion 160, the contact detection portion 170, and the movement planning portion 180) may be provided inside a cloud server device, for example.

The information processing device 200 includes, for example, an environment identification portion 210, a map information generation portion 220, a map information storing portion 230, and a contact position detection portion 240. The information processing device 200 may be wholly provided inside an external environment. The map information generation portion 220 corresponds to one specific example of a “second generation portion” according to the present disclosure. The map information storing portion 230 corresponds to one specific example of a “second memory portion” according to the present disclosure. The contact position detection portion 240 corresponds to one specific example of a “position calculation portion” and a “transmission portion” according to the present disclosure.

Some of the components of the information processing device 200 (for example, the environment identification portion 210 and the contact position detection portion 240) may only be provided inside an external environment. At this time, the rest of the components of the information processing device 200 (for example, the map information generation portion 220 and the map information storing portion 230) may be provided inside a cloud server device, for example.

The environment identification portion 110 includes the non-contact sensor 40. The environment identification portion 110 uses the non-contact sensor 40, recognizes (senses) an external environment, and generates recognition data Dr (sensing data) corresponding to the external environment through the recognition (sensing). The Robot coordinate system R-xyz is used to express the recognition data Dr. The environment identification portion 110 outputs the generated recognition data Dr to the map information generation portion 120.

The map information generation portion 120 processes the recognition data Dr inputted from the environment identification portion 110 on the basis of an environment map Mr(t-1) at a previous time. The map information generation portion 120 further uses recognition data Dr′ that has undergone the process to build up an environment map Mr(t) at a current time. The map information generation portion 120 causes the map information storing portion 130 to store the acquired environment map Mr(t) at the current time.

The map information storing portion 130 includes, for example, a volatile memory such as a dynamic random access memory (DRAM) or a non-volatile memory such as an electrically erasable programmable read-only memory (EEPROM) or a flash memory. The map information storing portion 130 is memorizing an environment map Mr. The environment map Mr is, for example, a map database including the environment map Mr(t) at the current time, which is inputted from the map information generation portion 120. The Robot coordinate system R-xyz is used to express the environment map Mr.

The movement planning portion 150 creates a movement plan to integrate maps on the basis of the environment map Mr read from the map information storing portion 130 and its own position data (current position data). The movement planning portion 150 creates, for example, a movement plan necessary for causing the end effector at the terminal of one of the manipulators 21 to reach a target position (a touch position) on the basis of the environment map Mr read from the map information storing portion 130 and its own position data (the current position data). The movement planning portion 150 determines, for example, a route along which the terminal of the one of the manipulator 21 moves from the current position that is calculated from its own position data (the current position data). The movement planning portion 150 further determines an orientation and a posture at which the one of the manipulator 21 takes. The movement planning portion 150 then outputs, as a movement plan, a result of the determinations to the movement control portion 160.

The movement control portion 160 generates a control signal that controls the one of the manipulators 21 on the basis of the movement plan inputted from the movement planning portion 150, and outputs the control signal to the one of the manipulators 21. That is, the movement control portion 160 controls motion of the one of the manipulators 21 on the basis of the environment map Mr. The one of the manipulators 21 moves on the basis of the control signal inputted from the movement control portion 160. When the terminal of the one of the manipulators 21 reaches the target position (the touch position), the one of the manipulators 21 presses, with the end effector of the one of the manipulators 21, for example, the object (or the article) at the target position (the touch position) with predetermined pressure.

The contact detection portion 170 includes the contact sensors 20 provided to the end effectors of the manipulators 21. The contact detection portion 170 uses one of the contact sensors 20 to determine whether or not the terminal of the corresponding one of the manipulators 21 has reached the target position (the touch position). The contact detection portion 170 determines whether or not the terminal of the one of the manipulators 21 has reached the target position (the touch position) on the basis of detection data acquired from the one of the contact sensors 20, for example. When it is determined that the terminal of the one of the manipulators 21 has reached the target position (the touch position), the contact detection portion 170 generates a signal (a contact flag) indicating that the terminal has reached there. The contact detection portion 170 transmits the generated contact flag to the information processing device 200 via wireless communications.

The map information integration portion 140 uses position information (contact position information) of inside the external environment, with which portion the terminal of the one of the manipulators 21 is in contact, integrates the environment map Mr and an environment map Me (described later) acquired from the information processing device 200 with each other, and generates a integration map Mc.

The map information integration portion 140 acquires the contact position information pertaining to the terminal of the one of the manipulators 21 from the movement control portion 160 that controls motion of the manipulators 21. The map information integration portion 140 further acquires contact position information pertaining to the terminal of the one of the manipulators 21 also from the contact position detection portion 240 of the information processing device 200. Note herein that the contact position information pertaining to the terminal of the one of the manipulators 21, which is acquired from the movement control portion 160 that controls motion of the manipulators 21, will be referred to as first contact position information for purpose of convenience. The Robot coordinate system R-xyz is used to express the first contact position information that corresponds to the value of p^{r}_{touch}. Furthermore, the contact position information pertaining to the terminal of the one of the manipulators 21, which is acquired from the contact position detection portion 240 of the information processing device 200, will be referred to as second contact position information for purpose of convenience. The environment coordinate system E-xyz is used to express the second contact position information that corresponds to the value of p^{e}_{touch}.

Next, the map information integration portion 140 uses, for example, Expression (9) illustrated in FIG. 8 or Expression (10) illustrated in FIG. 10 to derive its own position p^{w}_{r-xyz}. At this time, a touch position p^{w}_{r-xyz}+p^{r}_{touch} acquired via the Robot coordinate system R-xyz and a touch position p^{w}_{e-xyz}+p^{e}_{touch} acquired via the environment coordinate system E-xyz indicate a position common to each other. The touch position p^{w}_{r-xyz}+p^{r}_{touch} acquired via the Robot coordinate system R-xyz and the touch position p^{w}_{e-xyz}+p^{e}_{touch} acquired via the environment coordinate system E-xyz are therefore associated with each other to integrate the environment map Mr and the environment map Me (described later) acquired from the information processing device 200 with each other. In this way, the map information integration portion 140 generates the integration map Mc. The map information integration portion 140 may cause the map information storing portion 130 to store the generated integration map Mc, for example. At this time, the movement planning portion 180 uses the integration map Mc read from the map information storing portion 130 to create a movement plan.

By the way, when the integration map Mc is to be generated, the terminal of the one of the manipulators 21 is in contact with the object (or the article) at the target position (the touch position). That is, the integration map Mc is used to control motion of the manipulators 21 and other components while the terminal of the one of the manipulators 21 is in contact with the object (or the article) at the target position (the touch position).

The movement planning portion 180 creates a movement plan for executing a predetermined task on the basis of the integration map Mc generated by the map information integration portion 140 and its own position data (the current position data). A predetermined task refers to, for example, an action of gripping a predetermined object (for example, the camera placed in the book shelf 2) inside an external environment using the other one of the manipulators 21, which differs from the one of the manipulators 21, which is in contact with the object in the external environment. The one of the manipulators 21, which is in contact with the object in the external environment, will be hereinafter referred to as a “manipulator 21a” for purpose of convenience. Furthermore, the other one of the manipulators 21, which differs from the manipulator 21a, will be hereinafter referred to as a “manipulator 21b” for purpose of convenience.

The movement control portion 190 generates a control signal that controls the manipulator 21b on the basis of the movement plan inputted from the movement planning portion 180, and outputs the generated control signal to the manipulator 21b. The manipulator 21b moves on the basis of the control signal inputted from the movement control portion 160. The manipulator 21b executes a predetermined task while the terminal of the manipulator 21a is in contact with the object (or the article) at the target position (the touch position).

The environment identification portion 210 includes the non-contact sensor 50. The environment identification portion 210 uses the non-contact sensor 50, recognizes (senses) an external environment, and generates recognition data De corresponding to the external environment through the recognition (sensing). The environment coordinate system E-xyz is used to express the recognition data De. The environment identification portion 210 outputs the generated recognition data De to the map information generation portion 220.

The map information generation portion 220 processes the recognition data De inputted from the environment identification portion 210 on the basis of an environment map Me(t-1) at a previous time. The map information generation portion 220 further uses recognition data De′ that has undergone the process to build up an environment map Me(t) at a current time. The map information generation portion 220 causes the map information storing portion 230 to store the acquired environment map Me(t) at the current time.

The map information storing portion 230 includes, for example, a volatile memory such as a DRAM or a non-volatile memory such as an EEPROM or a flash memory. The map information storing portion 230 is memorizing the environment map Me. The environment map Me is, for example, a map database including the environment map Me(t) at the current time, which is inputted from the map information generation portion 220. The environment coordinate system E-xyz is used to express the environment map Me.

The contact position detection portion 240 periodically acquires the environment map Me from the map information storing portion 230. When a contact flag is inputted from the contact detection portion 170, the contact position detection portion 240 calculates contact position information (second contact position information) pertaining to the terminal of the one of the manipulators 21, which is included in the acquired environment map Me, i.e., the contact position of the terminal of the one of the manipulators 21 inside the external environment. The contact position detection portion 240 transmits the calculated second contact position information and the environment map Me to the map information integration portion 140 of the information processing device 100.

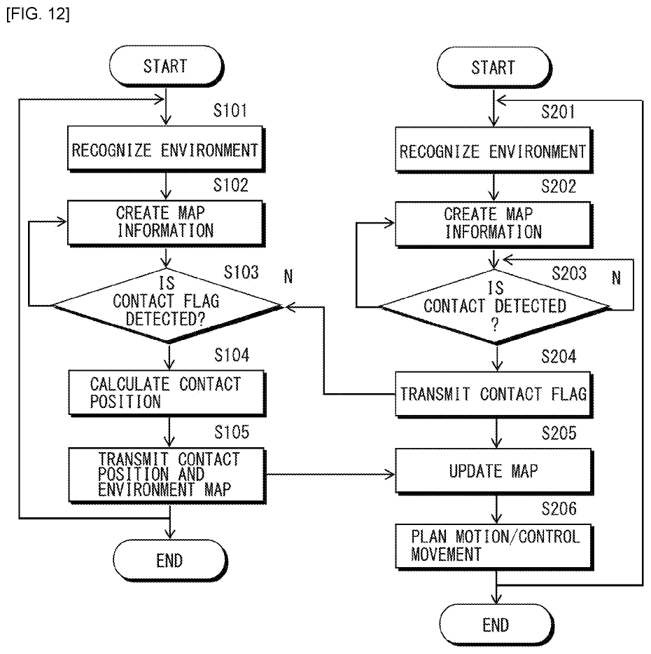

Next, an information processing procedure executed in the information processing system 1000 will be described. FIG. 12 illustrates an example of the information processing procedure executed in the information processing system 1000.

In the information processing device 100, the environment identification portion 110 uses the non-contact sensor 40 to recognize (sense) an external environment (step S101). The environment identification portion 110 thereby generates the recognition data Dr (sensing data) corresponding to the external environment. The environment identification portion 110 outputs the generated recognition data Dr to the map information generation portion 120. Next, the map information generation portion 120 uses the inputted recognition data Dr to create map information (the environment map Mr(t) at a current time) (step S102). The map information generation portion 120 causes the map information storing portion 130 to store the acquired map information (the environment map Mr(t) at the current time). The movement control portion 160 controls motion of the manipulators 21 on the basis of the environment map Mr(t) at the current time. One of the manipulators 21 moves on the basis of a control signal inputted from the movement control portion 160 to allow the terminal of the one of the manipulators 21 to come into contact with an object (or an article) at a target position (a touch position).

In the information processing device 200, the environment identification portion 210 uses the non-contact sensor 50 to recognize (sense) an external environment (step S201). The environment identification portion 210 thereby generates the recognition data De (sensing data) corresponding to the external environment. The environment identification portion 210 outputs the generated recognition data De to the map information generation portion 220. Next, the map information generation portion 220 uses the inputted recognition data De to create map information (the environment map Me(t) at a current time) (step S202). The map information generation portion 220 causes the map information storing portion 230 to store the acquired map information (the environment map Me(t) at the current time).

The contact detection portion 170 determines whether or not the terminal of the one of the manipulators 21 has come into contact with the object on the basis of detection data acquired from the corresponding one of the contact sensors 20 (step S203). When it is determined that the terminal of the one of the manipulators 21 has come into contact with the object, the contact detection portion 170 transmits a contact flag to the contact position detection portion 240 (step S203; Y, step S204). The contact position detection portion 240 determines whether or not there is an input of a contact flag from the contact detection portion 170 (step S103). When it is detected that there is an input of the contact flag from the contact detection portion 170, the contact position detection portion 240 calculates a contact position of the terminal of the one of the manipulators 21, which is included in the environment map Me (step S103; Y, step S104). The contact position detection portion 240 transmits the calculated contact position and the environment map Me to the map information integration portion 140 (step S105).

The map information integration portion 140 uses the contact position information acquired from the movement control portion 160 and the contact position information acquired from the contact position detection portion 240, integrates the environment map Mr and the environment map Me with each other, and generates the integration map Mc. The map information integration portion 140 generates the integration map Mc while the terminal of the one of the manipulators 21 is in contact with the object (or the article) at the target position (the touch position), for example. The map information integration portion 140 updates the integration map Mc in this way (step S205). After that, the movement planning portion 180 creates a movement plan for executing a predetermined task on the basis of the integration map Mc and its own position data (the current position data) (step S206). The movement control portion 190 controls motion of the manipulator 21b on the basis of the movement plan inputted from the movement planning portion 180 (step S206). As a result, the manipulator 21b executes the predetermined task.

By the way, the manipulator 21a is in contact with the object (or the article) at the target position (the touch position) while the map information integration portion 140 is integrating the maps and while the manipulator 21b is executing the predetermined task. The manipulator 21b is thereby able to accurately execute the predetermined task.

Next, effects of the information processing system 1000 will be described.

In the present embodiment, position information of inside an external environment, with which portion the manipulator 21a is in contact, is used. The environment map Mr and the environment map Me are then integrated with each other. The integration map Mc is thereby generated. It is thereby possible to accurately identify a portion where the environment map Mr and the environment map Me correspond to each other, making it possible to perform stable and prompt manipulation.

Furthermore, the environment map Me used in the present embodiment is a map of an external environment including a portion of an external environment that the non-contact sensor 40 is at least able to sense. It is assumed at this time that the manipulator 21a be in contact with an object at a predetermined position inside an environment corresponding to both the external environment that the non-contact sensor 40 is able to sense and an external environment that the non-contact sensor 50 is able to sense. It is thereby possible to use contact position information (p^{r}_{touch}) acquired from the movement control portion 160 and contact position information (p^{e}_{touch}) acquired from the contact position detection portion 240 to acquire p^{w}_{r-xyz} with a smaller error of e^{w}_{r-xyz}. As a result, it is thereby possible to accurately identify a portion where the environment map Mr and the environment map Me correspond to each other, making it possible to perform stable and prompt manipulation.

Furthermore, in the present embodiment, a contact position of the manipulator 21a, which is calculated using the environment map Me, and the environment map Me are transmitted to the information processing device 100. The contact position of the manipulator 21a, which is calculated using the environment map Me, and a contact position of the manipulator 21a, which is calculated using the environment map Ma, are used. The environment map Mr and the environment map Me are then integrated with each other. The integration map Mc is thereby generated. It is thereby possible to accurately identify a portion where the environment map Mr and the environment map Me correspond to each other, making it possible to perform stable and prompt manipulation.

Furthermore, in the present embodiment, the map information storing portion 130 may be caused to store the generated integration map Mc. In such a case, the movement planning portion 180 is able to use the integration map Mc read from the map information storing portion 130 to create a movement plan.

Furthermore, sensor data acquired from the non-contact sensor 50 is used to generate the environment map Me in the present embodiment. It is thereby possible to use the non-contact sensor 50 to generate the environment map Me for a region for which no environment map has been prepared beforehand. As a result, it is possible to use the non-contact sensor 50 to generate the environment map Me for such a closed region as a secluded region deep inside each of the racks of the book shelf 2, for example.

### 2. Modification Examples

Next, modification examples to the information processing system 1000 will be described.

### Modification Example A

In the embodiment described above, the robot machine 1 may include a plurality of the manipulators 21a. In this case, the movement control portion 160 outputs control signals to the plurality of manipulators 21a on the basis of a movement plan inputted from the movement planning portion 150. The manipulators 21a may respectively simultaneously come into contact with an object or objects at target positions (touch positions) that differ from each other on the basis of control signals inputted from the movement control portion 160.

In the embodiment described above, the robot machine 1 may include a manipulator 21c having not only its terminal, but also a portion corresponding to an elbow, which is able to also come into contact with an object inside an external environment, for example. In this case, the movement control portion 160 outputs control signals to the manipulator 21c on the basis of a movement plan inputted from the movement planning portion 150. The manipulator 21c may use, for example, the terminal and the portion corresponding to the elbow to simultaneously come into contact with an object or objects at target positions (touch positions) that differ from each other on the basis of control signals inputted from the movement control portion 160.

In such a case, the map information integration portion 140 is able to generate the integration map Mc on the basis of contact position information pertaining to a plurality of portions with higher relative positional accuracy. The map information integration portion 140 generates the integration map Mc while, for example, a plurality of manipulators such as the manipulator 21a and the manipulator 21c is simultaneously in contact with a plurality of portions inside an external environment. It is thereby possible to accurately identify a portion where the environment map Mr and the environment map Me correspond to each other, making it possible to perform stable and prompt manipulation.

### Modification Example B

In the embodiment described above, the movement control portion 160 may sequentially output a plurality of control signals to the manipulator 21a on the basis of a movement plan inputted from the movement planning portion 150. At this time, the manipulator 21a may sequentially come into contact with an object or objects at target positions (touch positions) that differ from each other on the basis of the sequentially inputted plurality of control signals. In such a case, the map information integration portion 140 is able to generate the integration map Mc on the basis of contact position information pertaining to a plurality of portions with higher relative positional accuracy. The map information integration portion 140 generates the integration map Mc while the manipulator 21a sequentially comes into contact with a plurality of portions inside an external environment, for example. It is thereby possible to accurately identify a portion where the environment map Mr and the environment map Me correspond to each other, making it possible to perform stable and prompt manipulation.

### Modification Example C

FIGS. 13, 14, and 15 each illustrate an example article that is placed inside an external environment and that serves as a measurement target in the information processing systems 1000 according to the embodiment and its modification examples described above.

FIG. 13 illustrates, as such an article, a protruding portion 61 having a distinctive shape inside the external environment. The protruding portion 61 has, for example, a bar shape protruding in normal directions, compared with those around it. The protruding portion 61 is, for example, gripped by the end effector at the terminal of the manipulator 21a or pressed by the end effector at the terminal of the manipulator 21a. It is possible to detect, with a pressure sensor provided to the end effector, for example, whether the end effector has gripped the protruding portion 61 or has pressed the protruding portion 61.

FIG. 14 illustrates a sponge portion 62 having distinctive hardness inside an external environment. The sponge portion 62 includes, for example, a sponge material that is softer than those around it. The sponge portion 62 is, for example, pressed by the end effector at the terminal of the manipulator 21a. It is possible to detect, with a pressure distribution sensor or a vision system tactile sensor provided to the end effector, for example, whether or not the end effector has pressed the sponge portion 62. The vision system tactile sensor detects a change in surface shape of the end effector.

FIG. 15 illustrates a texture portion 63 having distinctive texture inside an external environment. The texture portion 63 includes, for example, a plurality of rough surfaces 63a and a plurality of smooth surfaces 63b. The plurality of rough surfaces 63a and the plurality of smooth surfaces 63b are alternately provided inside a two dimensional surface, as illustrated in FIG. 15, for example. It is possible to detect roughness of the texture portion 63 with, for example, a tactile sensor provided to the end effector at the terminal of the manipulator 21a.

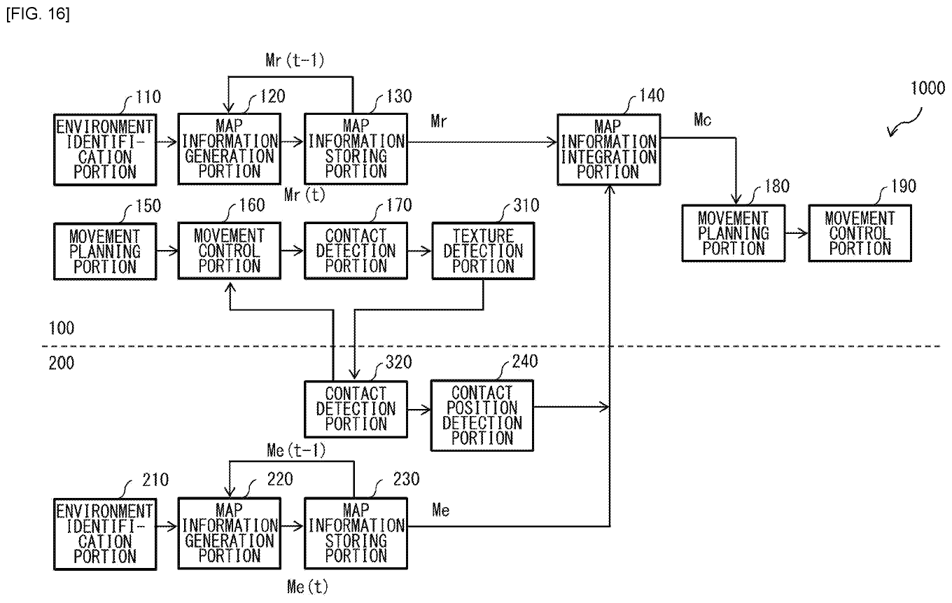

FIG. 16 illustrates an example of the functional blocks of the information processing system 1000 according to the present modification example. In the embodiment and its modification examples described above, the information processing device 100 further includes a texture detection portion 310 and the information processing device 200 further includes a contact detection portion 320.

The contact detection portion 170 uses the contact sensor 20 to detect whether or not the terminal of the manipulator 21a has come into contact with an object. When it is detected that the terminal of the manipulator 21a has come into contact with an object, the contact detection portion 170 generates and outputs a contact flag to the texture detection portion 310. When the contact flag is inputted from the contact detection portion 170, the texture detection portion 310 detects, on the basis of sensing data from the contact sensor 20, a physical feature (for example, a distinctive shape, distinctive hardness, or distinctive texture) of the portion with which the terminal of the manipulator 21a has come into contact. The texture detection portion 310 outputs a detection result (the physical feature) to the contact detection portion 320, together with the contact flag.

In the present modification example, the environment map Me includes a physical feature at a portion with which the terminal of the manipulator 21a comes into contact. The contact detection portion 320 compares the physical feature included in the environment map Me with the detection result (the physical feature) inputted from the contact detection portion 170. When both the physical features coincide with each other as a result, the contact detection portion 320 determines that the terminal of the manipulator 21a has accurately come into contact with the object at a scheduled contact position, and outputs a contact flag to the contact position detection portion 240. At this time, the map information integration portion 140 generates the integration map Mc while the manipulator 21a is in contact with the portion having the distinctive shape, distinctive hardness, or distinctive texture in the external environment, for example. On the other hand, when both the physical features do not coincide with each other, the contact detection portion 320 determines that the terminal of the manipulator 21a has come into contact with the object or another object at a position that differs from the scheduled contact position, and outputs a predetermined correction amount to the movement control portion 160.

It is thereby possible to use information of the distinctive shape, distinctive hardness, or distinctive texture of the portion with which the terminal of the one of the manipulators 21 is in contact to correct a small error in contact position of the terminal of the one of the manipulator 21. As a result, it is possible to highly accurately detect the contact position of the manipulator 21a, making it possible to perform stable and prompt manipulation.

### Modification Example D

FIG. 17 illustrates a modification example to the functional blocks of the information processing systems 1000 according to the embodiment and its modification examples described above. In the present modification example, the information processing device 100 further includes a posture adjustment portion 330.

When the terminal of the manipulator 21a is in contact with an object (or an article) at a target position (a touch position), the posture adjustment portion 330 adjusts an orientation of the manipulator 21a and a posture of the main body 10. The posture adjustment portion 330 calculates a correction amount necessary for the adjustment and outputs the calculated correction amount to the movement control portion 160.

It is thereby possible to correct a state of the orientation of the manipulator 21a and the posture of the main body 10 when the terminal of the manipulator 21a is caused to come into contact with an object to a more preferable state. In Modification Example C, the contact sensor 20 provided at the terminal of the manipulator 21a is able to accurately detect, as a result, a feature of the protruding portion 61, the sponge portion 62, or the texture portion 63, for example. As a result, it is possible to perform stable and prompt manipulation.

### Modification Example E

In the embodiment and its modification examples described above, one of the contact sensors 20 provided at the terminals of the manipulators 21 may come into contact with an object in a region that the environment map Mr, the environment map Me, or the environment map Mc does not include. At this time, coordinates of the terminal of the one of the manipulators 21, when the corresponding one of the contact sensors 20 comes into contact with the object (the article), may be written in the environment map Mr. In such a case, the robot machine 1 is able to use the corresponding one of the contact sensors 20 to update the environment map Mc, even when it is not possible to update the environment map Mc using the non-contact sensor 40.

Although the present disclosure has been described with reference to the embodiment and its modification examples, including application examples and practical examples, the present disclosure is not limited to thereto, but may be modified in a wide variety of ways. It should be appreciated that the effects described herein are mere examples. Effects of an example embodiment of the technology are not limited to those described herein. The technology may further include any effect other than those described herein.

The present disclosure may further be able to have configurations as described below.
(1) An information processing system including:
   a first information processing device to be provided to a movable body; and
   a second information processing device to be provided to a portion that differs from the movable body,
   in which the first information processing device includes:
   a first sensor portion that senses a first external environment;
   a first generation portion that uses first sensor data acquired from the first sensor portion to generate a first map;
   a control portion that controls motion of a manipulator on the basis of the first map; and
   an integration portion that uses position information of inside the first external environment, with which portion the manipulator is in contact, integrates the first map and a second map acquired from the second information processing device with each other, and generates an integration map.
(2) The information processing system according to (1), in which
   the second map is a map of a second external environment including at least a portion of the first external environment, and
   the integration portion generates the integration map while the manipulator is in contact with a portion at a predetermined position inside an environment corresponding to both the first external environment and the second external environment.
(3) The information processing system according to (1) or (2), in which the second information processing device further includes:
   a position calculation portion that uses the second map to calculate a contact position of the manipulator; and
   a transmission portion that transmits the contact position and the second map to the first information processing device.
(4) The information processing system according to (3), in which the integration portion
   uses a contact position of the manipulator, the contact position being derived from control information of the control portion, and a contact position of the manipulator, the contact position being received from the second information processing device, as position information of inside the first external environment, with which portion the manipulator is in contact,
   integrates the first map and the second map with each other, and
   generates the integration map.
(5) The information processing system according to any one of (1) to (4), in which
   the first information processing device includes a first memory portion,
   the second information processing device includes a second memory portion stored with the second map, and
   the integration portion causes the first memory portion to store the integration map that is generated.
(6) The information processing system according to any one of (1) to (5), in which the second information processing device includes:
   a second sensor portion that senses the second external environment; and
   a second generation portion that uses second sensor data acquired from the second sensor portion to generate the second map.
(7) The information processing system according to any one of (1) to (6), in which the integration portion generates the integration map while the manipulator is in simultaneous contact with a plurality of portions inside the first external environment.
(8) The information processing system according to any one of (1) to (6), in which the integration portion generates the integration map while the manipulator sequentially comes into contact with a plurality of portions inside the first external environment.
(9) The information processing system according to any one of (1) to (8), in which the integration portion generates the integration map while the manipulator is in contact with a portion having a distinctive shape, distinctive hardness, or distinctive texture in the first external environment.
(10) An information processing method including:
   performing sensing to generate a first map of a first external environment;
   controlling motion of a manipulator on the basis of the first map; and
   using position information of inside the first external environment, with which portion the manipulator is in contact, integrating the first map and a second map of a second external environment including at least a portion of the first external environment with each other, and generating an integration map.
(11) The information processing method according to (10), further including generating the integration map while the manipulator is in contact with a portion at a predetermined position inside an environment corresponding to both the first external environment and the second external environment.
(12) The information processing method according to (10) or (11), further including:
   using the second map to calculate a contact position of the manipulator; and
   transmitting the contact position and the second map to a first information processing device to be provided to a movable body.
(13) The information processing method according to (12,) further including
   using a correspondence relation between a contact position of the manipulator, the contact position being derived from control information used to control motion of the manipulator, and a contact position of the manipulator, the contact position being received from a second information processing device to be provided to a portion that differs from the movable body, as position information of inside the first external environment, with which portion the manipulator is in contact,
   integrating the first map and the second map with each other, and
   generating the integration map.
(14) The information processing method according to any one of (10) to (13), further including generating the integration map while the manipulator is in simultaneous contact with a plurality of portions inside the first external environment.
(15) The information processing method according to any one of (10) to (13), further including generating the integration map while the manipulator successively comes into contact with a plurality of portions inside the first external environment.
(16) The information processing method according to any one of (10) to (15), further including generating the integration map while the manipulator is in contact with a portion having a distinctive shape, distinctive hardness, or distinctive texture inside the first external environment.
(17) An information processing device to be provided to a movable body,
   the information processing device including:
   a first sensor portion that senses a first external environment;
   a first generation portion that uses first sensor data acquired from the first sensor portion to generate a first map;
   a control portion that controls motion of a manipulator on the basis of the first map; and
   an integration portion that uses position information of inside the first external environment, with which portion the manipulator is in contact, integrates the first map and a second map acquired from a second information processing device to be provided to a portion that differs from the movable body with each other, and generates an integration map.

The information processing system, the information processing method, and the information processing device according to the embodiment of the present disclosure use position information of inside a first external environment, with which portion a manipulator is in contact, integrate a first map and a second map with each other, and generate an integration map. It is thereby possible to accurately identify a portion where the first map and the second map correspond to each other. As a result, it is possible to perform stable and prompt manipulation. Note that the effects of the present disclosure are not limited to those described above, and may be any effect described herein.

This application claims the benefit of Japanese Priority Patent Application JP 2021-034824 filed with the Japan Patent Office on Mar. 4, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An information processing system comprising:
a first information processing device to be provided to a movable body; and
a second information processing device to be provided to a portion that differs from the movable body,
the first information processing device including:
a first sensor portion that senses a first external environment;
a first generation portion that uses first sensor data acquired from the first sensor portion to generate a first map;
a control portion that controls motion of a manipulator on a basis of the first map; and
an integration portion that uses position information of inside the first external environment, with which portion the manipulator is in contact, integrates the first map and a second map acquired from the second information processing device with each other, and generates an integration map.

2. The information processing system according to claim 1, wherein
the second map is a map of a second external environment including at least a portion of the first external environment, and
the integration portion generates the integration map while the manipulator is in contact with a portion at a predetermined position inside an environment corresponding to both the first external environment and the second external environment.

3. The information processing system according to claim 2, wherein the second information processing device further comprising:
a position calculation portion that uses the second map to calculate a contact position of the manipulator; and
a transmission portion that transmits the contact position and the second map to the first information processing device.

4. The information processing system according to claim 3, wherein the integration portion
uses a contact position of the manipulator, the contact position being derived from control information of the control portion, and a contact position of the manipulator, the contact position being received from the second information processing device, as position information of inside the first external environment, with which portion the manipulator is in contact,
integrates the first map and the second map with each other, and
generates the integration map.

5. The information processing system according to claim 2, wherein
the first information processing device includes a first memory portion,
the second information processing device includes a second memory portion stored with the second map, and
the integration portion causes the first memory portion to store the integration map that is generated.

6. The information processing system according to claim 5, wherein the second information processing device includes:
a second sensor portion that senses the second external environment; and
a second generation portion that uses second sensor data acquired from the second sensor portion to generate the second map.

7. The information processing system according to claim 1, wherein the integration portion generates the integration map while the manipulator is in simultaneous contact with a plurality of portions inside the first external environment.

8. The information processing system according to claim 1, wherein the integration portion generates the integration map while the manipulator sequentially comes into contact with a plurality of portions inside the first external environment.

9. The information processing system according to claim 1, wherein the integration portion generates the integration map while the manipulator is in contact with a portion having a distinctive shape, distinctive hardness, or distinctive texture in the first external environment.

10. An information processing method comprising:
performing sensing to generate a first map of a first external environment;
controlling motion of a manipulator on a basis of the first map; and
using position information of inside the first external environment, with which portion the manipulator is in contact, integrating the first map and a second map of a second external environment including at least a portion of the first external environment with each other, and generating an integration map.

11. The information processing method according to claim 10, further comprising generating the integration map while the manipulator is in contact with a portion at a predetermined position inside an environment corresponding to both the first external environment and the second external environment.

12. The information processing method according to claim 11, further comprising:
using the second map to calculate a contact position of the manipulator; and
transmitting the contact position and the second map to a first information processing device to be provided to a movable body.

13. The information processing method according to claim 12, further comprising
using a correspondence relation between a contact position of the manipulator, the contact position being derived from control information used to control motion of the manipulator, and a contact position of the manipulator, the contact position being received from a second information processing device to be provided to a portion that differs from the movable body, as position information of inside the first external environment, with which portion the manipulator is in contact,
integrating the first map and the second map with each other, and
generating the integration map.

14. The information processing method according to claim 10, further comprising generating the integration map while the manipulator is in simultaneous contact with a plurality of portions inside the first external environment.

15. The information processing method according to claim 10, further comprising generating the integration map while the manipulator successively comes into contact with a plurality of portions inside the first external environment.

16. The information processing method according to claim 10, further comprising generating the integration map while the manipulator is in contact with a portion having a distinctive shape, distinctive hardness, or distinctive texture inside the first external environment.

17. An information processing device to be provided to a movable body,
the information processing device comprising:
a first sensor portion that senses a first external environment;
a first generation portion that uses first sensor data acquired from the first sensor portion to generate a first map;
a control portion that controls motion of a manipulator on a basis of the first map; and
an integration portion that uses position information of inside the first external environment, with which portion the manipulator is in contact, integrates the first map and a second map acquired from a second information processing device to be provided to a portion that differs from the movable body with each other, and generates an integration map.
